(19) United States
(12) Patent Application Publication
(10) Pub. No.: US 2004/0247083 A1
(43) Pub. Date: Dec. 9, 2004

(54) Apparatus for generating x-rays

(76) Inventors: Joseph Deuringer, Herzogenaurach (DE); Jorg Freudenberger, Baiersdorf (DE); Rolf Gurtner, Erlangen (DE); Peter Schardt, Hochstadt (DE)

Correspondence Address: SCHIFF HARDIN LLP, Patent Department, 6600 Sears Tower, 233 South Wacker Drive, Chiacgo, IL, 60606, US

(21) Appl. No.: 10/813,773

(22) Filed: Mar. 31, 2004

(30) Foreign Application Priority Data
Mar. 31, 2003 (DE) 103 14 537.0

(51) Int. Cl. H01J 35/02; H01J 35/10; H01J 35/12

(52) U.S. Cl. 378/141

(57) ABSTRACT

An apparatus for generating x-rays has a structural unit which contains an x-ray tube, a digital control, regulation and storage unit for operating the x-ray tube, and all other components associated with, and supporting, operation of the x-ray tube. All of the components in the structural unit are connected to the digital control, regulation and storage unit. The apparatus also includes a peripheral device having a process computer. The digital control, regulation and storage unit has an interface to the process computer, which forms a single interface to the process computer for all of the components of the structural unit.

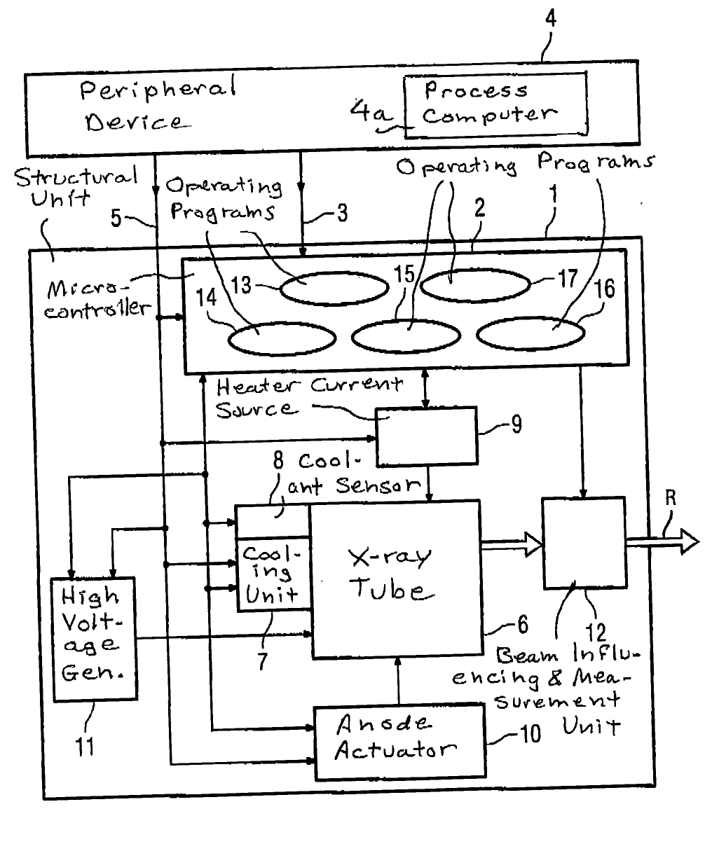

### BACKGROUND OF THE INVENTION

1. Field of the Invention

The present invention concerns an apparatus for generating x-rays.

2. Description of the Prior Art

Conventionally, a medical-technical x-ray apparatus such as an x-ray computed tomography apparatus has various components such as an x-ray tube, high-voltage generator, current supply for heating the cathode of the x-ray tube, devices to adjust the beam geometry, etc. The components are produced separately and are first connected with one another in the assembly of the x-ray apparatus. For this purpose, a number of connections among the components must be made. After the connections are made, it is additionally necessary to tune the components to one another. Thus, for example, a heat characteristic curve of the x-ray tube must be determined and stored in a controller for the heating. To calibrate the control for electrical actuator for the anode, for example, the inductance of the electrical actuation must be measured and stored as well. Such adaptations of the components to one another require a large expenditure of time.

### SUMMARY OF THE INVENTION

An object of the invention is to provide an apparatus for generating x-rays wherein the aforementioned disadvantages are avoided. In particular, such an apparatus should be able to be rapidly and simply connected with a peripheral device, for example a process computer to control the x-ray apparatus.

This object Is achieved according to the invention, by an apparatus for generating x-rays having an x-ray tube and a digital control, regulation and storage unit for the x-ray tube, with an interface to connect a process computer of a peripheral device to a structural unit, of which the x-ray tube and the digital control, regulation and storage unit are components.

As used herein, “peripheral device” means assembly units of the x-ray apparatus such as, for example, a device to move the x-ray tube relative to the patient, the process computer, a device to generate high voltage, and the like.

Since the aforementioned components are combined in a structural unit, they can mutually be connected with the process computer by means of the interface provided at the digital control, regulation and storage unit. It is no longer necessary to produce a separate connection of each component to the peripheral device. This reduces the assembly effort.

The apparatus can includes a heating device to heat the cathode in the x-ray tube, as well as at least one sensor to determine the temperature and/or the pressure of a coolant provided to cool the x-ray tube. The digital control, regulation and storage unit is appropriately connected with the heating device for regulation, as well as with the sensor to record measurement values.

The proper functioning of the heating and cooling of the x-ray tube substantially influences its function and durability. The regulation of the heating and the monitoring of the cooling ensue directly in the structural unit via the digital control, regulation and storage unit. Given a deviation from predetermine operation parameters, an appropriate regulation and, as warranted, a deactivation of the x-ray tube, can ensue. In the event of a fault, the structural unit can be rapidly replaced by another structural unit.

The digital control, regulation and storage unit operates according to a program to determine the acceptability of a load on the x-ray tube that a user intends to implement. The program takes into account the capacity and, as warranted data accumulated over the usage history of the x-ray tube. If the user requests a load that is too high, this information is transmitted to the digital control, regulation and storage unit and indicated to the user.

In a further embodiment, an electrical actuator for a rotating anode in the x-ray tube is included in the structural unit, and the digital control, regulation and storage unit is connected with the electrical actuator for control thereof.

In another embodiment, the digital control, regulation and storage unit operates according to a program to store the aforementioned operation data of the x-ray tube, Furthermore, it can operate according to a program to determine the wear of the x-ray tube and/or its expected remaining life from this data. This enables an accumulated recording of relevant operating data, and therewith an early wear and/or failure recognition. The operating data can be read out and evaluated at another location after an exchange of the apparatus, It is no longer necessary to read out such operating data, for example from the process computer of the peripheral device.

The digital control, regulation and storage unit also can operate according to a program to adjust and/or to control components that influence the beam geometry, in particular filters, diaphragms and the like. Naturally, the components that influence the beam geometry, in particular filters, diaphragms and the like, also can be components of the structural unit,

Furthermore, a device to generate the high-voltage necessary to operate the x-ray tube can be provided in the structural unit, connected with the digital control, regulation and storage unit for control thereof. Thus all components necessary to generate x-rays can be combined into a single structural unit. All components can mutually be controlled and/or regulated via the digital control, regulation and storage unit. The apparatus can be connected with the process computer via a single interface.

The term “structural unit” as used herein means a vendor-manufactured assembly unit, the components of which are tuned to one another. Further, separate adaptation of the components, once they have formed the structural unit, is not necessary. All components of the structural unit are appropriately connected with the digital control, regulation and storage unit in a finished manner. Its interface serves for connection with the aforementioned process computer. Depending on design, the components of the structural unit can be assembled on a common chassis or frame, or one or more of the components (such as, for example, the device to generate high voltage) can be mounted on a separate chassis. The structural unit Is appropriately incorporated in a common housing,

### DESCRIPTION OF THE DRAWINGS

The single figure shows an exemplary embodiment of an apparatus for generating x-rays in accordance with the invention.

### DESCRIPTION OF THE PREFERRED EMBODIMENTS

An x-ray apparatus is schematically shown in the figure. A structural unit 1 includes a digital control, regulation and storage unit, formed in this embodiment by a microcontroller 2, with an interface 3. In addition to the structural unit 1, the x-ray apparatus has a peripheral device 4 with, among other things, a process computer 4a that is connected with the structural unit 1 via the interface 3. The structural unit 1 also has a mains connection 5 for power supply.

A further basic component of the structural unit 1 is an x-ray tube 6 with an associated cooling unit 7 and sensors 8 to monitor the temperature and/or the pressure of the coolant. To heat the cathode (not shown) of the x-ray tube 6, a heater current source 9 is provided, as well as an anode actuator 10 to rotate the anode (not shown). A high-voltage generator 11 and the beam influencing and measurement unit 12 downstream from the x-ray tube 6 in the beam propagation direction R form further components of the structural unit 1.

The microcontroller 2 operates according to a first program 13 to control the basic operational procedure (cycle), a second program 14 to monitor the x-ray tube 6, a third program 15 to calculate the load requested by the user, a fourth program 16 to determine the wear of the x-ray tube 6, and a fifth program 17 to accumulate important operating data associated with usage of the x-ray tube 6.

Since all programs 13, 14, 15, 16, 17 necessary to control, regulate and monitor the x-ray tube 6 and the other components run in a single microcontroller 2, a continuous and rapid adjustment of the components and the x-ray tube 6 is possible. All relevant operating data of the x-ray tube 6 and/or of the components are simultaneously available to all programs 13, 14, 15, 16, 17. Depending on the requirements by the user, the operation of the X-ray tube 0 can be optimized by means of the microcontroller 2, such as to minimize wear. At the same time, the operating data of the x-ray tube 6 can be collected and evaluated via the fifth program 17 with regard to the degree of wear and the expected remaining life of the x-ray tube 6. An impending failure of the x-ray tube 6 can thus be recognized early and communicated to the user. Unwanted downtimes of the x-ray apparatus thus are prevented.

Although modifications and changes may be suggested by those skilled in the art, it is the intention of the inventors to embody within the patent warranted hereon all changes and modifications as reasonably and properly come within the scope of their contribution to the art.

1. An apparatus for generating x-rays comprising:
a structural unit containing a plurality of components operable in combination for generating x-rays, including an x-ray tube and a digital control, regulation and storage unit connected to all of said components, including being connected to said x-ray tube for controlling operation of said x-ray tube;
a peripheral device containing a process computer; and
said digital control, regulation and storage unit having an interface, accessible at said structural unit, to said process computer, said interface forming a single interface to said process computer for all of the components in said structural unit.

2. An apparatus as claimed in claim 1 wherein said x-ray tube has a cathode, and wherein said plurality of components include a heater current source connected to said cathode for heating said cathode.

3. An apparatus as claimed in claim 1 wherein said plurality of components include a cooling unit associated with said x-ray tube for circulating a coolant for cooling said x-ray tube, and a sensor for sensing at least one of a pressure and a temperature of said coolant.

4. An apparatus as claimed in claim 1 wherein said digital control, regulation and storage unit contains a program, and operates according to said program, for determining acceptability of a load on said x-ray tube requested by a user.

5. An apparatus as claimed in claim 1 wherein said x-ray tube has a rotating anode, and wherein said plurality of components include an electrical actuator for said rotating anode.

6. An apparatus as claimed in claim 1 wherein said digital control, regulation and storage unit contains a program, and operates according to said program to store accumulated operating data associated with operation of said x-ray tube.

7. An apparatus as claimed in claim 1 wherein said digital control, regulation and storage unit contains a program, and operates according to said program, to determine at least one of wear of said x-ray tube and an expected remaining life of said x-ray tube.

8. An apparatus as claimed in claim 1 wherein said digital control regulation and storage unit contains a program, and operates according to said program, for monitoring operation of said plurality of components, including monitoring operation of said x-ray tube.

9. An apparatus as claimed in claim 1 wherein said plurality of components include a high voltage generator connected to said x-ray tube for supplying high voltage to said x-ray tube for operating said x-ray tube.
